(19) United States
(12) Patent Application Publication
(10) Pub. No.: US 2017/0276054 A1
(43) Pub. Date: Sep. 28, 2017

(54) NITROGEN VAPORIZATION

(71) Applicant: Vita International, Inc., Houston, TX (US)

(72) Inventors: Khaled M. Shaaban, Houston, TX (US); Dinh Nguyen, Houston, TX (US)

(21) Appl. No.: 15/077,527

(22) Filed: Mar. 22, 2016

(51) Int. Cl. F01P 3/20; F01N 5/02; F17C 7/04

(52) U.S. Cl. CPC F01P 3/20; F17C 7/04; F01N 5/02; F17C 2265/036; F17C 2221/014; F17C 2205/0323; F17C 2250/03; F17C 2250/0631; F17C 2250/0636; F17C 2260/031

(57) ABSTRACT

Apparatus and methods for vaporizing liquid nitrogen at sufficient pressure, temperature, and volume to enable a single mobile pumper to meet the needs of many industrial applications. The dual-mode nitrogen pumper of the present invention utilizes a reciprocating pump and heat from the engine coolant and exhaust stream of an internal combustion engine, as well as heat from hydraulic fluid used to load the engine, and transfers that heat to liquid nitrogen pumped through a first heat exchanger and a second, internally-fired heat exchanger is provided to transfer heat to liquid nitrogen pumped through a second heat exchanger. The temperature of the hydraulic fluid is maintained, and the temperature, pressure, and flow rate of the vaporized nitrogen is controlled, by balancing the engine load against the nitrogen pumping rate.

### BACKGROUND OF THE INVENTION

The present invention relates to the pumping and vaporizing of cryogenic fluids, more specifically liquid nitrogen. In more detail, the present invention relates to mobile pumpers and vaporizers and methods for vaporizing liquid nitrogen in sufficient volumes and at the varying pressures and temperatures that enable the use of the vaporized nitrogen in the many applications in which vaporized nitrogen is commonly required. For instance, vaporized nitrogen is used in downstream application in refineries and petrochemical plants for inerting, blanketing, and drying as well as for more specialized applications such as accelerated cooldowns of reactors, high temperature drying, and catalyst regeneration. Vaporized nitrogen is also used in midstream applications for pipeline drying, pressure testing, and pigging. On the upstream side of the oil and gas industry, vaporized nitrogen is commonly used in various well servicing and stimulation applications, including formation fracturing, energized acidizing, fluids lifting, and well bore workover.

Current available nitrogen pumpers typically employ one method of vaporization per pumper, either direct-fired or non-fired (non-fired pumpers are also referred to as heat recovery or flameless vaporizers). The preferred method of vaporization largely depends on the requirements of the specific application, the required flow capacity and vaporized nitrogen gas temperature being key factors in determining the appropriate vaporization method. For example, pumpers equipped with a direct-fired vaporizer are typically utilized in applications requiring vaporized nitrogen flow rates greater than 3000 scfm. The fired vaporization method is exclusively used when the vaporized nitrogen temperature requirement exceeds 300 F. The method of vaporization also depends on the restrictions applicable to the area of operations, for example, the direct fired method of vaporization is not permissible in areas where volatile gases/fuel may exist in the atmosphere. Another example of possible restrictions is in areas where states such as the state of California impose significant regulatory limits on emissions of greenhouse gases.

In recent years, a few nitrogen pumpers were built to include more than one method of nitrogen vaporization. These pumpers are known as “dual-mode pumpers” and “hybrid-pumpers”. In one embodiment of the hybrid-pumper, a non-fired vaporizer, created within the engine coolant circuit, is configured in series with a direct-fired vaporizer. In this first embodiment of a hybrid-pumper, exemplified by U.S. Pat. No. 8,943,842, the non-fired vaporizer is in fluid flow communication with a cryogenic pump that is also in fluid flow communication with a cryogenic source/tank. Further, the non-fired vaporizer is in fluid flow communication with a diesel direct-fired vaporizer in the downstream, where the non-fired vaporizer is described to form a “heated stream” accepted by the direct-fired vaporizer located downstream of the non-fired vaporizer. A drawback of this hybrid-pumper embodiment is that there is limited heat available for the non-fired vaporizer from the internal combustion engine powering the hybrid-pumper, and no provision is made for creating additional load on the pumper's power source (the pumper's internal combustion diesel engine) as is typical of existing non-fired mobile pumpers, which results in significantly limited non-fired vaporization capacity. More specifically, the heat generation capacity from the internal combustion engine of this embodiment of a hybrid-pumper is strictly limited to the heat generated due to just the consequential parasitic load on the engine. As such, this type of hybrid-pumper is clearly not designed to impose any additional artificial load on its diesel engine, thus having limited vaporization capability through its non-fired vaporizer if operated independently of its direct-fired vaporizer, and cannot therefore truly be operated to deliver the vaporization rates similar to an independent/typical pumper equipped only with a non-fired vaporizer which render the hybrid pumper as described having a very limited scope/capability while operating with only its non-fired vaporizer. Further, the “in series” configuration of the hybrid-pumper direct-fired and non-fired vaporizers allows an increase in its non-fired vaporization capacity only when the direct-fired vaporizer is actually in use. This type of hybrid-pumper, configured with in series vaporizers, effectively makes for a hybrid-pumper only in the sense that it is practically a typical direct-fired pumper with provisions for collecting additional (parasitic) engine heat through its non-fired vaporizer; the only other significant source of heat is the direct-fired exhaust stream, which requires the hybrid-pumper's direct-fired vaporizer to be engaged in order for some of the heat available from the direct-fired vaporizer exhaust stream to be captured in the hybrid-pumper coolant circuit, thus increasing the vaporization capacity of its non-fired vaporizer.

A second embodiment of a dual-mode pumper is also configured with two distinct vaporizers, one of which is a diesel direct-fired vaporizer and the other a non-fired vaporizer, and is similar in that regard to the first embodiment of hybrid-pumper described above. However, a key difference in this second embodiment of dual-mode pumper, exemplified by the DMP pumpers operated by Cudd Energy Services (Houston, TX), is that the non-fired and the diesel direct-fired vaporizers are configured in parallel where the non-fired vaporizer is not in fluid communication with the direct-fired vaporizer. Another key difference in this second type of dual-mode pumper is that the main cryogenic pumps are powered hydraulically and not through a transmission and shaft as is the case in the first embodiment of a hybrid-pumper described above. Further, this second embodiment of a dual-mode pumper is capable of operating its dual vaporizers independently of one another, allowing the dual-mode pumper to operate as either a non-fired pumper or a direct fired pumper independently. Therefore, the operator of this second type of dual-mode pumper must actually select which of the two methods of vaporization to use in order to meet the application-specific requirements for vaporized nitrogen flow rate and temperature.

Although this second embodiment of a dual-mode pumper offers certain operating advantages, there is still a need for an improved dual-mode pumper equipped with at least two nitrogen vaporizers combining a direct-fired and a non-fired vaporizers on a single mobile pumper configuration. More specifically, there is a need for a nitrogen pumper that is capable of improved vaporization efficiencies, reduced fuel consumption, and lower emissions of greenhouse gases to atmosphere. Such advantages can be achieved with a dual-mode nitrogen vaporizer that includes a direct-fired vaporizer and a non-fired vaporizer configured in parallel and working collectively while performing applications requiring higher output volume, temperature, and/or pressure, but that is also capable of operating the fired and non-fired vaporizers independently of one another whenever necessary. The present invention offers a single pumper equipped with direct-fired and non-fired nitrogen vaporizers that offers higher vaporization capacity than that of the above-described hybrid and dual-mode pumpers. The improved pumper with dual nitrogen vaporizers of the present invention is capable of delivering vaporized nitrogen at pressures up to about 10,000 psi and delivering vaporized nitrogen temperatures ranging from about −300 F to about 600+ F and flow rates up to about 740,000 scfh as required in performing such applications as are described above, and it is therefore an object of the present invention to provide a dual-mode nitrogen pumper that is capable of delivering vaporized nitrogen at these pressures, temperatures, and flow rates by operating in a true dual-mode manner.

The improved dual-mode nitrogen pumper of the present invention is also provided with several unique control features that effectively simplify and automate pumper operations, and it is therefore an object of the present invention to provide further improvements in the operation and overall efficiency of nitrogen vaporization. More specifically, it is an object of the present invention to provide a nitrogen pumper with an unfired heat exchanger that operates at levels not previously capable of being achieved without utilizing a direct-fired heat exchanger, enabling the use of the nitrogen pumper of the present invention in applications such as those described above requiring strictly flameless operation and/or limited emissions. A further advantage of the improved dual-mode pumper of the present invention is the ability to provide high temperature (up to about 300 F) nitrogen, depending upon flow rate, utilizing only the unfired vaporizer. So far as is known, and despite claims made in U.S. Pat. No. 8,943,842, no other purely unfired vaporizer is capable of outputting vaporized nitrogen at temperatures up to 300 F. These advantages and levels of performance are accomplished in part by matching the heat generated by the engine of the improved dual-mode pumper of the present invention to the flow rate of the nitrogen when the pumper is operated in the unfired mode in that engine load is proportional to the nitrogen flow rate, enabling greater volumes of nitrogen to be pumped as engine temperature increases. It is an object of the present invention to provide a dual-mode nitrogen pumper that monitors engine temperature, specifically, by monitoring the temperature of hydraulic fluid, so as to dynamically balance available engine heat with nitrogen flow rate while at the same time maintaining the temperature of the hydraulic fluid within a specified temperature range for optimal life of the hydraulic fluid and hydraulic components.

Another object of the present invention is to provide a dual-mode nitrogen pumper that compensates for engine load and the heat produced by the engine and the pumping power of the nitrogen pumper, changing the load on the engine to increase the available heat for operation in the unfired mode under control of operating rules programmed into a controller that is operably connected to the appropriate sensors and actuators for opening and closing a sequential valve in the hydraulic circuit of the pumper and for increasing or decreasing fuel consumption based on a fuel consumption map stored in the memory of a programmable logic controller for compensation of engine load and pumping power when operated in the direct-fired mode. More specifically, it is an object of the present invention to provide an improved dual-mode pumper that splits the available horsepower of the internal combustion engine of the pumper by driving the pump for pumping the nitrogen mechanically from a gearbox or transfer case and by driving the hydraulic circuit used to transfer heat from that same gearbox/transfer case, thereby avoiding such operating difficulties as the killing of the engine when nitrogen pressure is high by dropping the drag on the hydraulic circuit and using more of the horsepower to power the nitrogen pump.

Another object of the present invention is to provide a dual-mode nitrogen pumper that is capable of being built on, for instance, a three or four-axle truck chassis, trailer, or skid, that outputs vaporized nitrogen in sufficient volume and at selected temperature and pressure that a single unit can be utilized for such applications as gel fracking, nitrogen fracking, and unfreezing frozen pipe, and for such applications as nitrogen cooling of a reactor in a refinery for maintenance and then bringing that same reactor back online after maintenance by pumping nitrogen at temperatures of 600+ degrees F., all controlled dynamically and without changing connections, supply lines, or the operating parameters of the nitrogen pumper, and even under programmed control.

Other objects, and the many advantages of the present invention, will be made clear to those skilled in the art in the following detailed description of the preferred embodiment(s) of the invention and the drawing(s) appended hereto. Those skilled in the art will recognize, however, that the embodiment(s) of the present invention that are described herein are only examples of specific embodiment(s), set out for the purpose of describing the making and using of the present invention, and that the embodiment(s) shown and/or described herein are not the only embodiment(s) of an apparatus and/or method constructed and/or performed in accordance with the teachings of the present invention. Further, although described herein as having particular application to certain operations, as noted above, those skilled in the art who have the benefit of this disclosure will recognize that the present invention may be utilized to advantage in many applications, the present invention being described with reference to the applications described herein for the purpose of exemplifying the invention, and not with the intention of limiting its scope.

### SUMMARY OF THE INVENTION

The present invention meets the above-described objects by providing a liquid nitrogen vaporizer including an internal combustion engine with circulating engine coolant fluid that absorbs heat produced by operation of the engine and that produces hot exhaust gases while the engine is artificially loaded by driving a hydraulic pump that forces the hydraulic fluid through a sequential valve, comprising a source of liquid nitrogen with a reciprocating pump having an input connected to the liquid nitrogen source and an output. A first heat exchanger receives liquid nitrogen from the output of the reciprocating pump and outputs vaporized nitrogen, the heat for the first heat exchanger being stripped from the coolant of the operating internal combustion engine and the hydraulic fluid pumped by operation of the internal combustion engine. A second heat exchanger also receives liquid nitrogen from the output of the reciprocating pump and outputs vaporized nitrogen, the heat for said second heat exchanger being obtained by combustion of fuel, and a valve is provided for mixing liquid nitrogen with vaporized nitrogen output from either or both of the first or said second heat exchangers. A programmable logic controller monitors and varies the fuel consumed by the internal combustion engine for the purpose of maintaining either an operator-selected output temperature of vaporized nitrogen, an operator-selected output flow of vaporized nitrogen, or an operator-selected temperature and flow of vaporized nitrogen, the programmable logic controller being operatively connected to a valve for increasing or decreasing the fuel consumption of the internal combustion engine.

In another aspect, the present invention provides a method of vaporizing with a nitrogen vaporizer comprising a heat recovery vaporizer and a direct fired vaporizer powered by an internal combustion engine comprising the steps of splitting the horsepower output from the internal combustion engine between a mechanical drive for pumping nitrogen to the vaporizers and a hydraulic circuit for providing waste heat from the internal combustion engine to the heat recovery vaporizer and balancing the load imposed on the internal combustion engine by the hydraulic circuit with the load imposed on the engine by the nitrogen pump by monitoring the temperature of the hydraulic fluid and the flow rate and pressure of the nitrogen and using the temperature, flow rate, and pressure data to increase engine speed when nitrogen pressure decreases and to pump more nitrogen when engine speed increases.

In a third aspect, the above-described objects are met by providing a method of maintaining the temperature of the hydraulic fluid within the hydraulic circuit of a heat recovery vaporizer for vaporizing a cryogenic gas including an internal combustion engine for powering a hydraulic circuit, the engine being loaded by a sequential valve located in the hydraulic circuit and the cryogenic gas being pumped through the heat recovery vaporizer comprising the steps of selecting a temperature range at which the hydraulic fluid is to be maintained, monitoring hydraulic fluid temperature, and pumping cryogenic gas through the heat recovery vaporizer at a rate that strips only so much heat from the hydraulic fluid, or enough heat from the hydraulic fluid, as to maintain the temperature of the hydraulic fluid at the selected temperature range.

### BRIEF DESCRIPTION OF THE DRAWINGS

FIG. 1 is a schematic, or layout, diagram of a system incorporating a nitrogen vaporizer constructed in accordance with the teachings of the present invention.

FIG. 2 is also a schematic, or layout, diagram and shows one embodiment of instrumentation and controls for operating the nitrogen vaporizing system of FIG. 1.

FIG. 3 is a diagram showing a programmable logic controller (PLC) and the inputs and outputs to the PLC for operating the controls and instrumentation of FIG. 2.

### DETAILED DESCRIPTION OF THE PREFERRED EMBODIMENT(S)

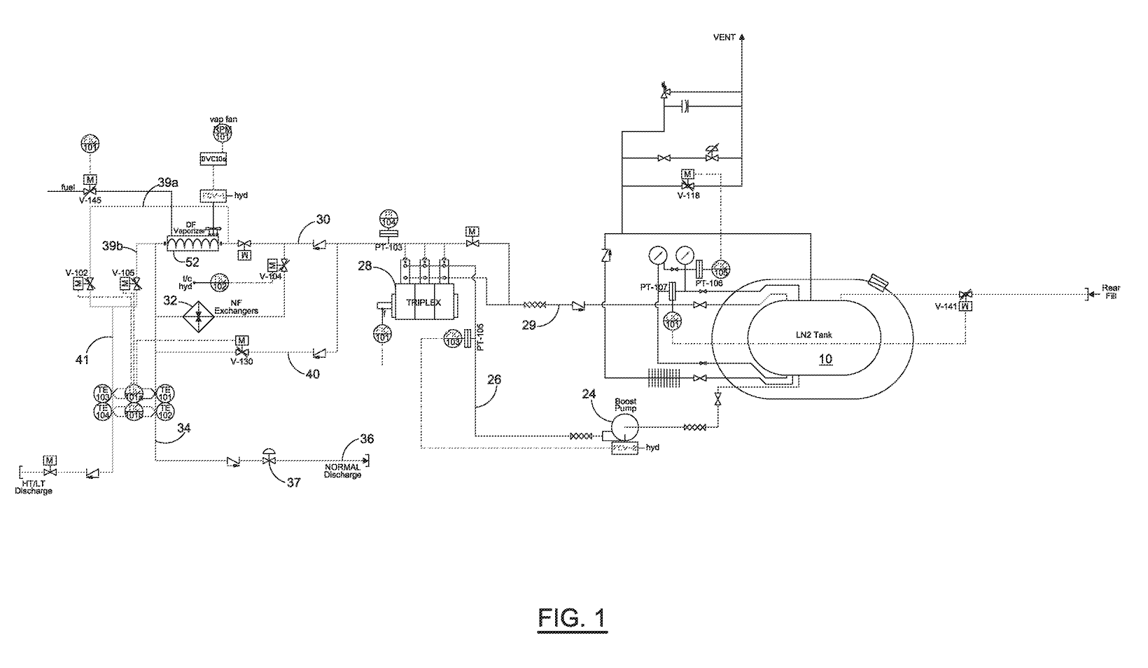

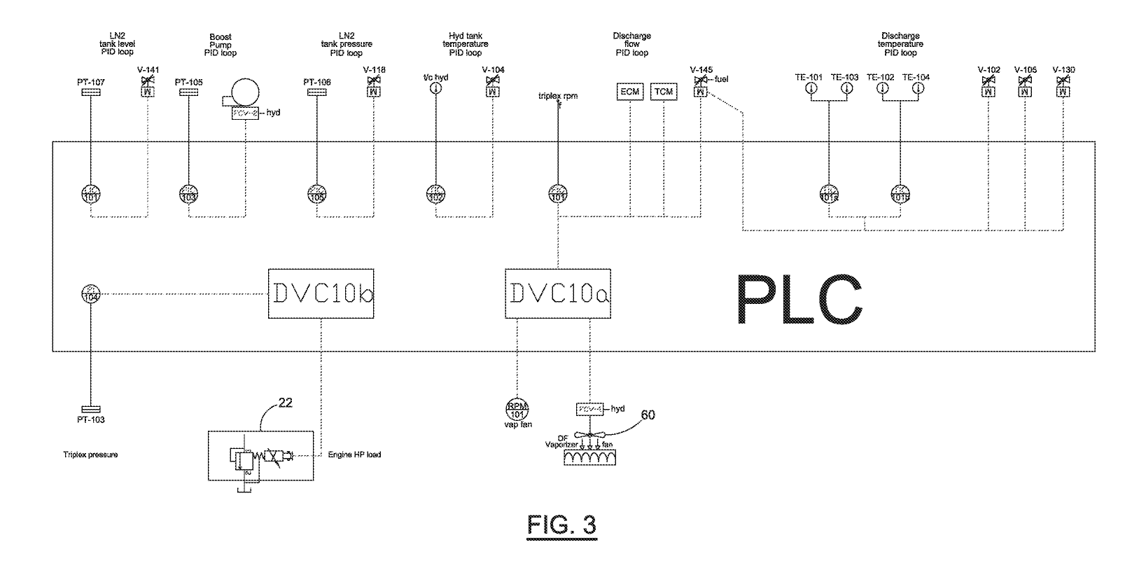

Referring to FIG. 1, liquid nitrogen is provided to a storage tank 10 by one or more cryogenic transport trucks (not shown) or other sources that may be filled through a loading manifold (not shown), all in accordance with known liquid nitrogen storage and handling systems. Liquid nitrogen is output from storage tank 10 through supply line 16 to the nitrogen vaporizer of the present invention, indicated generally at reference numeral 18, that is itself powered by an internal combustion engine 19 that may be diesel powered or powered by other hydrocarbon fuels such as gasoline or natural gas. The internal combustion engine 19 of nitrogen vaporizer 18 is “artificially” loaded by driving a hydraulic pump 20 that pumps hydraulic fluid through the restricted orifice 22 (see FIG. 3) of a sequencing valve, the engine 19 producing more heat that is “captured” in the engine coolant as engine 19 works harder and burns more fuel to push hydraulic fluid through valve orifice 22. In the embodiment described herein, the internal combustion engine 19 of nitrogen vaporizer 18 provides three heat sources, the hydraulic fluid, the engine exhaust, and the high temperature engine coolant, and all three heat sources are used to advantage in the method and apparatus described below.

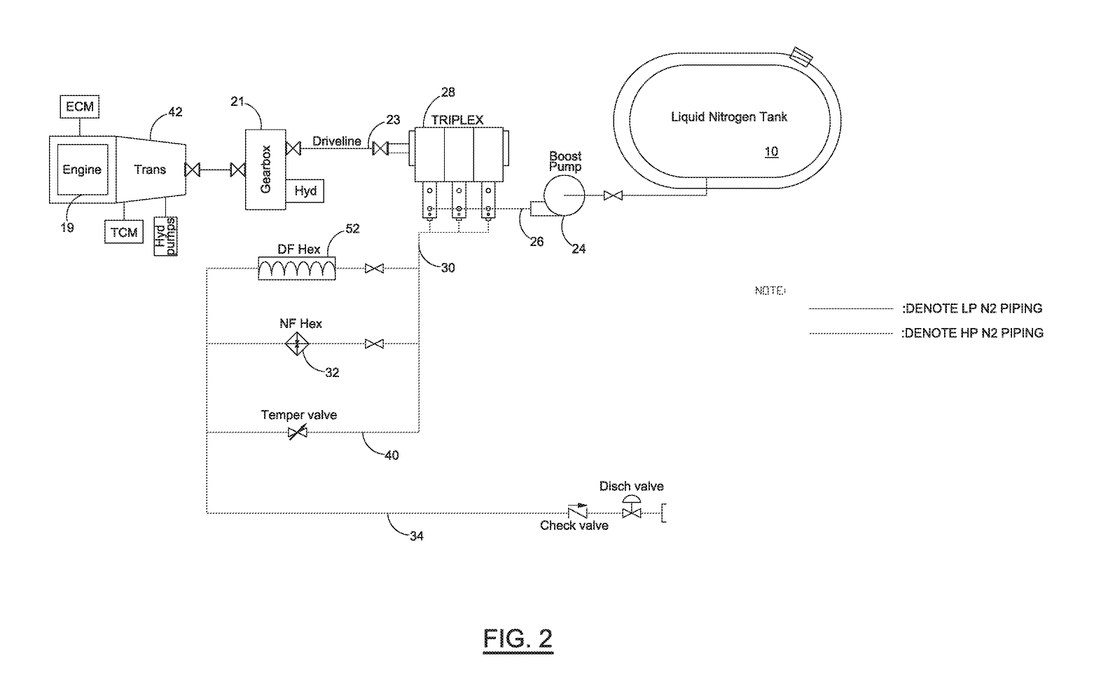

As set out below in connection with the description of FIG. 2, the engine 19 of nitrogen vaporizer 18 also powers a hydraulically-driven booster pump 24 provided for the purpose of feeding liquid nitrogen through line 26 to the suction side of a reciprocating pump 28, which may be a simplex, duplex, triplex, or other multiple-cylinder pump. Those skilled in the art who have the benefit of this disclosure will recognize that the booster pump 24 is not always utilized, and may not even be needed, in installations in which the nitrogen source, such as storage tank 10 or transport trucks, provides liquid nitrogen at sufficient pressure to the suction side of reciprocating pump 28. For instance, some cryogenic tanks provide liquid nitrogen at sufficient pressure that a booster pump is not needed and some cryogenic tanks are provided with internal pumps that provide liquid nitrogen at the pressure needed at the suction side of reciprocating pump 28. A pressure indicator controller PIC-103 is provided in the line 26 and pressure is monitored at pressure transducer PT-105 for controlling boost pump 24 in a manner known in the art. In a preferred embodiment, the output from boost pump 24 is maintained at sufficient pressure by outputting sufficient flow from boost pump 24 to ensure the suction side of pump 28 is always fed with sufficient nitrogen (see below). If nitrogen is provided to the suction side of pump 28 in a volume exceeding the net positive suction pressure (NPSP) of pump 28, excess nitrogen is returned to tank 10 through line 29.

Reciprocating pump 28 builds sufficient pressure in the input line 30 to the unfired and direct-fired heat exchangers 32, 52 to overcome the 200-1000 psi pressure drop characteristic of passage through a heat exchanger with the result that the nitrogen output through line 34 to the nitrogen tank 36 or other equipment can be in the 500-10,000 psi range, more particularly, 500-5000 psi, to overcome further pressure drop or resistance downstream depending upon the needs of the particular installation or application. The pressure in input line 30 is monitored by pressure transducer PT-103 and, in the particular embodiment shown, displayed at pressure indicator PI-103. As discussed briefly above, the tank/other equipment indicated generally at reference numeral 36 is an industrial plant, electric power plant, temporary pipeline, a well head for applications in which the vaporized nitrogen is utilized at volumes and pressures sufficient for well servicing and/or oilfield operations, or any of the many other applications and/or installations in which nitrogen is used to advantage. As also shown in FIG. 1, output line 34 is provided with a valve 37 and line 39 for routing the nitrogen through liquid line 39A and hot gas line 39B with valves V-102 and V-105 for mixing the nitrogen exiting line 41 to a selected discharge temperature ranging from a nominal—320 F to temperatures of about 500 F or more directly to the industrial plant or any of the many other applications and/or installations in which large volumes of pressurized nitrogen at a selected temperature are used to advantage.

As noted above, the internal combustion engine 19 of LNG vaporizer 18 outputs three heat sources, and first heat exchanger 32 receives inputs from the engine coolant at temperatures typically ranging between about 120-160 degrees F. and the hydraulic fluid used to load engine 19 at temperatures typically ranging between about 120-160 degrees F. (see below for further discussion of the hydraulic fluid temperature). The third heat source, namely the engine exhaust, enters heat exchanger 32 at temperatures ranging between about 300 degrees F. up to temperatures as high as 1000 degrees F. The heat exchanger 32 that strips heat from hydraulic fluid, engine coolant, and exhaust together comprise the unfired nitrogen vaporizer of the present invention and additional details of the construction and operation are described in more detail in co-pending application Ser. No. 14/085,783, filed Nov. 20, 2013, the entirety of which is hereby incorporated into the present application by this specific reference.

The temperature of the fluid in the hydraulic circuit including sequencing valve 22 is monitored at temperature indicator controller TIC-102 comprising a portion of the unfired vaporizer and utilized as an input to a programmable logic controller (PLC) 100 (see below) for operating the actuator of V-104 of the sequencing valve 22 in the hydraulic circuit, the valve 22 responding to changes in temperature at TIC-102 to maintain a set temperature range, selected by an operator at PLC 100, in the hydraulic fluid, within the range specified by the manufacturer of the hydraulic fluid for maximizing the life and performance of the hydraulic fluid, and hence the components of the hydraulic circuit. As set out above, as sequencing valve 22 is opened and/or closed, the internal combustion engine 19 works harder against the hydraulic pressure to build heat in the hydraulic circuit and/or backs off to dissipate heat.

No matter how well the nitrogen storage tank 10 is insulated, some vapor is lost from tank 10 which may be vented to the atmosphere. Alternatively, the present invention may be provided with means to collect the vapor from storage tank 10 (and/or the transport trucks or other storage equipment) and direct that collected vapor back to tank 10, thus preventing the vapor/gas from being vented to the atmosphere and preserving the nitrogen for meaningful use. Appropriate controls and valves are provided for this purpose as known in the art, including a tank level pressure transducer PT-107, level indicator controller LIC-101, pressure transducer PT-106, and pressure indicator controller PIC-106.

A second heat exchanger is also shown in FIG. 1. Second heat exchanger 52 is a direct-fired heat exchanger (rather than the non-fired, or heat recovery, exchanger 32) and, like non-fired heat exchanger 32, receives liquid nitrogen output from pump 28 such that first and second heat exchangers 32 and 52 are connected into the nitrogen flow in parallel. Output from heat exchanger 52 passes through TIC-101 and out through line 34 and valve 37, valves V-102 and V-105 being closed. The hot gas in line 34 is mixed with liquid nitrogen in tempering line 40 using modulating valve V-130 under control of PIC-101 to obtain vaporized nitrogen at the temperature selected by the operator.

Referring now to FIGS. 2 and 3, the RPM of reciprocating pump 28 is monitored by flow indicator controller FIC-101, providing PLC 100 with the nitrogen flow rate into line 30. To obtain a selected flow rate, the speed of engine 19 and transmission gear selection is controlled to give the shaft RPM at pump 28 that provides the required flow rate into line 30 under control of PLC 100. Those skilled in the art will recognize that the speed of engine 19 and the particular gear in which the transmission 42 is operated can also be controlled manually and also that some control of flow rate into line 30 can also be obtained by varying engine speed or the particular gear of transmission 42. The outputs from PLC 100 are shown at engine control module ECM and transmission control module TCM on FIG. 3.

A shown in FIG. 2, when the improved dual mode pumper of the present invention is in pumping mode, the power from engine 19 is diverted through the gearbox 21 with two output pads (the output pads, being a part of gearbox 21, are not separately designated in the figures). One of the output pads is utilized for driving a hydraulic pump for changing the orifice of sequential valve 22 for loading the engine 19 to burn fuel and produce heat. The second pad is equipped with a driveshaft 23 for driving reciprocating pump 28. As noted above, this configuration of the engine 19, transmission 42, and gearbox 21 enables engine horsepower to be distributed through the transmission 42 to gearbox 21 so that a portion of the horsepower drives driveshaft 23 and the balance of the horsepower drives the hydraulic package, thereby maximizing utilization of engine horsepower for loading engine 19 for use in non-fired vaporization. As also shown in FIG. 2, a separate power take-off PTO is provided as a power source for a second hydraulic circuit powering the fired vaporizer fuel pump, nitrogen booster pump, auxiliary coolant pump, vaporizer cooling fan 60 (see below), the hydraulic and lube oil cooling fans, the flameless vaporizer coolant pump, and the lubricating system for reciprocation pump 28, all of which are known in the art and therefore not shown in the figures.

Referring now to FIG. 3, a programmable logic controller (PLC) is indicated generally at reference numeral 100. The operator selects, or activates, a particular control module at PLC 100, for instance, the pressure of the nitrogen output through line 34. Appropriate prompts are utilized by the operator to select the required flow rate, then the control module for selecting the temperature of the nitrogen output is activated and temperature selected, and so on, all in accordance with methods known in the art. As shown in FIG. 3, inputs from the various pressure, flow, temperature, and other indicators summarized above are likewise monitored at PLC 100 and adjustments made in engine speed, nitrogen flow rate, and so on in accordance with pre-programmed operating rules for maintaining operator selected pressure, flow, and temperature. More specifically, to increase nitrogen output, nitrogen temperature, or both flow and temperature when operated in dual mode, PLC 100 is programmed with a fuel consumption map that enables PLC 100 to call for opening (or closing) of fuel control valve V-145 to increase (or decrease) engine speed taking the heat available from the unfired vaporizer into consideration. The speed of the hydraulically-powered vaporizer fan 60 is also controlled from PLC 100 through flow control valve FCV-1. Those skilled in the art will recognize that with the operating flexibility and the level of control provided by PLC 100, the improved dual mode pumper of the present invention is capable of being operated at speeds and at the 120-140 degree F. temperatures that maintain the optimal viscosity of the hydraulic fluid and therefore the longevity of the component parts of the pumper.

The improved dual-mode (fired and un-fired) nitrogen pumper of the present invention offers certain advantages and efficiencies that, on information and belief, cannot be accomplished with previous nitrogen pumpers. For instance, it will be noted that direct-fired and heat recovery vaporizers can be bypassed to discharge liquid nitrogen as required for some applications. Further, the improved dual mode pumper of the present invention is capable of working pressures up to 10,000 psi and can deliver vaporized nitrogen at temperatures ranging from nominal temperature of about—320 F up to about 500 F. Vaporizer selection is made by an operator depending on desired flow rate and temperature of the application. In flameless mode, the pumper of the present invention is capable of delivering vaporized nitrogen at rates up to 4200 scfm at 70 F (and even higher flow rates depending upon the horsepower available from internal combustion engine 19). In direct fired mode, the pumper is capable of vaporized nitrogen flow rates over 12,000 scfm at 70+ F and up to 500 F at lower flow rates. For purposes of comparison, and referring again to U.S. Pat. No. 8,943,842, the hybrid-pumper described in that prior patent is described as consuming an estimated 29 gal/hr of fuel to produce an estimated 216,000 scfh, but that hybrid-pumper can only achieve that output by operating in direct-fired mode. The dual-mode pumper of the present invention consumes an estimated 27 gal/hr to produce that same estimated output, but the dual-mode pumper of the present invention produces that same estimated output without using the direct-fired vaporizer, thereby enabling operation in flameless environments and/or in environments in which emissions must be limited. Further, the output pressure required has minimal effect on the fuel consumption of the improved dual mode pumper of the present invention because the dual mode pumper of the present invention is capable of such gas output pressure in unfired mode. To further illustrate a further advantage of the dual-mode pumper of the present invention, at an estimated 540,000 scfh at 65-70 F, the dual-mode pumper of the present invention burns an estimated one gallon of fuel per minute as compared to typical consumption rates approximately 1.5 to 2 greater than one gal/min as a result of the efficient use of the non-fired vaporizer 32.

Those skilled in the art who have the benefit of this disclosure will also recognize that changes can be made to the component parts of the present invention without changing the manner in which those component parts function and/or interact to achieve their intended result. All such changes, and others that will be clear to those skilled in the art from this description of the preferred embodiment(s) of the invention, are intended to fall within the scope of the following, non-limiting claims.

1. A liquid nitrogen vaporizing system including an internal combustion engine with circulating engine coolant fluid that absorbs heat produced by operation of the engine and produces hot exhaust gases while the engine is artificially loaded by driving a hydraulic pump that forces the hydraulic fluid through the restricted orifice of a sequential valve, thus heating the hydraulic fluid, comprising:
a source of liquid nitrogen;
a reciprocating pump having an input connected to said liquid nitrogen source and an output;
a first heat exchanger for receiving liquid nitrogen from the output of said reciprocating pump and outputting vaporized nitrogen, the heat for said first heat exchanger being stripped from the heated coolant of the operating internal combustion engine, the heated hydraulic fluid pumped by operation of the internal combustion engine, and the engine exhaust gas;
a second heat exchanger for receiving liquid nitrogen from the output of said reciprocating pump and outputting vaporized nitrogen, the heat for said second heat exchanger being obtained by combustion of fuel within a fired burner; and
a valve for mixing liquid nitrogen with vaporized nitrogen output from either or both of said first or said second heat exchangers.

2. The nitrogen vaporizing system of claim 1 additionally comprising a programmable logic controller for monitoring and varying the fuel consumed by the fired burner of said second heat exchanger for the purpose of maintaining either an operator-selected output temperature of vaporized nitrogen, an operator-selected output flow of vaporized nitrogen, or an operator-selected temperature and flow of vaporized nitrogen, said programmable logic controller being operatively connected to a valve for increasing or decreasing the fuel consumption of the fired burner.

3. The nitrogen vaporizing system of claim 2 wherein said programmable logic controller is programmed with a fuel consumption map.

4. The nitrogen vaporizing system of claim 1 additionally comprising sensors and controls for maintaining the temperature of the hydraulic fluid pumped by the internal combustion engine within an optimal temperature range.

5. The nitrogen vaporizing system of claim 1 additionally comprising sensors and controls for maintaining the discharge temperature of the vaporized nitrogen by either the fired, the unfired, or both the fired and unfired vaporizers at a selected temperature by changing one or more of the volume of nitrogen liquid, nitrogen vapor, or cold nitrogen gas mixed with the vaporized nitrogen.

6. A method of vaporizing liquid nitrogen with a nitrogen vaporizer comprising a heat recovery vaporizer and a direct fired vaporizer powered by an internal combustion engine comprising the steps of:
splitting the horsepower output from the internal combustion engine between a mechanical drive for pumping nitrogen to the vaporizers and a hydraulic circuit for providing waste heat from the internal combustion engine to the heat recovery vaporizer; and
balancing the load imposed on the internal combustion engine by the hydraulic circuit with the load imposed on the engine by the nitrogen pump by monitoring pumped nitrogen pressure data and either opening or closing a sequential valve located in the hydraulic circuit in response to changes in pressure.

7. The method of claim 6 wherein hydraulic fluid temperature is changed by opening or closing the sequential valve, thereby increasing or decreasing heat to the unfired vaporizer, and wherein shaft rotation of the mechanical drive of the nitrogen pump is monitored as to increases or decreases in the volume of nitrogen pumped.

8. The method of claim 6 additionally comprising a programmable logic controller (PLC) operably connected to the direct fired vaporizer for changing fuel consumption in response to a pre-programmed fuel consumption map stored in the memory of the PLC.

9. A method of maintaining the temperature of the hydraulic fluid within the hydraulic circuit of a heat recovery vaporizer for vaporizing a cryogenic liquid including an internal combustion engine for powering a hydraulic circuit, the engine being loaded by a sequential valve located in the hydraulic circuit and the cryogenic liquid being pumped through the heat recovery vaporizer comprising the steps of selecting an optimal temperature range at which the hydraulic fluid is to be maintained, monitoring hydraulic fluid temperature, and pumping cryogenic liquid through the heat recovery vaporizer at a rate that strips only so much heat from the hydraulic fluid, or enough heat from the hydraulic fluid, as to maintain the temperature of the hydraulic fluid at an optimal temperature range.

10. The method of claim 9 additionally comprising the step of changing engine load to increase or decrease the amount of heat available to the heat recovery vaporizer.

11. The method of claim 9 wherein hydraulic fluid temperature is maintained at an optimal temperature range selected for maximizing the service life of the components of the hydraulic circuit.

12. The method of claim 9 additionally comprising the step of reducing the fuel consumption and combustion gas emissions of the fired vaporizer by vaporizing a portion of the pumped cryogenic liquid with the unfired vaporizer.
